(19) United States
(12) Patent Application Publication
(10) Pub. No.: US 2023/0071700 A1
(43) Pub. Date: Mar. 9, 2023

(54) ELECTRODE, PREPARATION METHOD AND USES THEREOF

(71) Applicant: Nanjing University of Science and Technology, Nanjing (CN)

(72) Inventors: Weiqing HAN, Nanjing (CN); Kajia WEI, Nanjing (CN); Xu YIN, Nanjing (CN); Jie ZHANG, Nanjing (CN); Lu WANG, Nanjing (CN); Zijie ZHOU, Nanjing (CN); Xiaodong LIU, Nanjing (CN); Xiuyun SUN, Nanjing (CN); Jiansheng LI, Nanjing (CN); Jinyou SHEN, Nanjing (CN)

(21) Appl. No.: 17/697,874

(22) Filed: Mar. 17, 2022

(30) Foreign Application Priority Data
Sep. 6, 2021 (CN) 202111035860.5

(51) Int. Cl. C02F 1/461; C02F 1/467

(52) U.S. Cl. CPC C02F 1/46109; C02F 1/4672; C02F 2001/46142; C02F 2103/06

(57) ABSTRACT

An electrode includes a microporous titanium substrate coated with a catalytic layer, and the catalytic layer includes magnetic SnO₂—Sb particles. The magnetic SnO₂—Sb particles are attached to the microporous titanium substrate through an external magnetic field. The microporous titanium substrate includes a plurality of membrane pores having a pore size of 5-50 μm that is smaller than a particle size of the magnetic SnO₂—Sb particles.

### CROSS-REFERENCE TO RELATED APPLICATIONS

Pursuant to 35 U.S.C.§ 119 and the Paris Convention Treaty, this application claims foreign priority to Chinese Patent Application No. 202111035860.5 filed Sep. 6, 2021, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the field of electrochemical oxidation and water treatment, and more particularly, to an electrode comprising a catalyst layer comprising magnetic SnO₂—Sb particles, a preparation method and uses thereof.

Wastewater usually contains toxic and persistent organic compounds which cannot be degraded in natural ways or by conventional biochemical treatment. The wastewater is discharged into natural environment, which causes damage to the ecological environment. In recent years, a conductive separation membrane electrode has attracted widespread attention for wastewater treatment because it outcompetes a conventional flat plate electrode in mass transfer and thus improves the removal efficiency of pollutants. A conventional Ti/SnO₂—Sb membrane electrode assembly exhibits excellent catalytic activity and high oxygen evolution potentials. However, the thermal distortion and crystal structure difference between the catalytic layer and the substrate leads to an unstable binding and a relatively short service life of the Ti/SnO₂—Sb membrane electrode assembly.

### SUMMARY

The disclosure provides an electrode comprising a microporous titanium substrate coated with a catalytic layer. Specifically, SnO₂—Sb xerogel powders and iron tetroxide nanoparticles are mixed, calcined, and ground into microparticles; the microparticles are magnetically bound to a microporous titanium substrate to form an electrode comprising a catalyst layer comprising magnetic SnO₂—Sb particles. The following advantages are associated with the electrode: (1) the microporous titanium substrate is loaded with the microparticles and the space between the microparticles and the pores of the microporous titanium substrate improves the filtering efficiency of the electrode on the pollutants; (2) the microparticles preferentially absorb the pollutants thus reducing chances of the pollutants to block the membrane pores; (3) the thickness of the catalyst layer is adjustable, and the catalyst layer is dynamically replaceable, thus overcoming the disadvantages of a conventional Ti/SnO₂—Sb electrode, such as low catalyst loading and unstable binding.

The first objective of the disclosure is to provide an electrode; the electrode comprises a microporous titanium substrate coated with a catalytic layer, and the catalytic layer comprising magnetic SnO₂—Sb particles; the magnetic SnO₂—Sb particles are attached to the microporous titanium substrate through an external magnetic field; and the microporous titanium substrate comprises a plurality of membrane pores having a pore size of 5-50 μm that is smaller than a particle size of the magnetic SnO₂—Sb particles. The catalytic layer comprising the magnetic SnO₂—Sb particles is dynamically attached to the microporous titanium substrate through external force, so that the catalytic layer acts as a secondary membrane on the substrate, which can be separated from the substrate through backwashing and can be recycled.

In a class of this embodiment, the particle size of the magnetic SnO₂—Sb particles is 1.2-2.5 times the pore size of the membrane pores. The magnetic SnO₂—Sb particles are attached to the outer surface of the microporous titanium substrate and the space between the microparticles and the pores of the microporous titanium substrate improves the filtering efficiency of the electrode on the pollutants.

In a class of this embodiment, the particle size of the magnetic SnO₂—Sb particles is 1.5-2.0 times the pore size of the membrane pores.

In a class of this embodiment, the magnetic SnO₂—Sb particles are composite particles comprising SnO₂—Sb xerogel powders and magnetic nanoparticles; the capacity of the magnetic nanoparticles on the microporous titanium substrate is 5-75 mg/cm²; and the magnetic property of the magnetic SnO₂—Sb particles is produced by the iron tetroxide particles in the size of 50-200 nm.

The second objective of the disclosure is to provide a method for preparing the electrode, the method comprising: filtering and loading the magnetic SnO₂—Sb particles onto the microporous titanium substrate to form a catalyst layer; and fixing the catalyst layer on the microporous titanium substrate through a magnetic field to form the electrode comprising the catalyst layer comprising the magnetic SnO₂—Sb particles.

In a class of this embodiment, operations for preparing the magnetic SnO₂—Sb particles comprise:

S1. preparation of SnO₂—Sb xerogel powders;

S2. preparation of a Sn—Sb precursor solution;

S3. dispersing the SnO₂—Sb xerogel powders and the iron tetroxide nanoparticles in the Sn—Sb precursor solution to form a mixture; heating, calcining, and grinding the mixture to form the magnetic SnO₂—Sb particles.

In a class of this embodiment, the operations for preparing the magnetic SnO₂—Sb particles comprise:

S1. preparation of the SnO₂—Sb xerogel powders:

mixing an ethanol solution of SnCl₄.5H₂O, a NH₄F aqueous solution, and a hydrochloric acid solution of SbCl₃ to form a mixed solution; dissolving an ethanol solution of propylene oxide in the mixed solution and heating to form a white gel; adding an ethanol solution of tetraethyl orthosilicate to the white gel, resting, sonicating, washing the white gel with n-hexane, air drying, and heating in a muffle furnace, to yield a SnO₂—Sb gel; and grinding the gel, sieving through a mesh sieve, thus obtaining the SnO₂—Sb xerogel powders;

S2. preparation of the Sn—Sb precursor solution:

mixing citric acid, ethylene glycol, SnCl₄.5H₂O, and SbCl₃ to form the Sn—Sb precursor solution;

S3. preparation of the magnetic SnO₂—Sb particles:

mixing the SnO₂—Sb xerogel powders with the iron tetroxide nanoparticles to form a powder mixture; adding the Sn—Sb precursor solution to the powder mixture to form a solution; heating the solution to evaporate solvents, thus obtaining a black solid block; calcining the black solid block in the muffle furnace; grinding and sieving the black solid block, immersing in an acid, and drying to obtain the magnetic SnO₂—Sb particles.

In a class of this embodiment, in S2, a molar ratio of citric acid to ethylene glycol to SnCl₄.5H₂O to SbCl₃ is 140:30:9:1.

In a class of this embodiment, in S3, the iron tetroxide nanoparticles have a particle size of 50-200 nm, and the SnO₂—Sb xerogel powders have a particle size of 10-50 μm; and/or

in S3, a mass ratio of the iron tetroxide nanoparticles to the SnO₂—Sb xerogel powders is between 1:1 and 1:3; and/or

in S3, every 10 mL of the Sn—Sb precursor solution is added to 10 g of the powder mixture; and/or

in S3, the black solid block is calcined in the muffle furnace at a temperature of 350-550° C. with a heating rate of 1.5-5° C./min for 0.5-2 h; and/or

in S3, the mesh sieve is a 200-800 mesh sieve; and the acid is 5-10 wt. % sulfuric acid, hydrochloric acid, or nitric acid.

The third objective of the disclosure is to provide an electrochemical device that comprises the electrode comprising a catalyst layer comprising magnetic SnO₂—Sb particles, and the electrode is used an anode.

The fourth objective of the disclosure is to provide a method for treatment of wastewater comprising humic substances, the method comprising horizontally placing the electrochemical device of claim 10 on ground, the electrochemical device comprising the electrode as an anode, and perforated stainless steel as a cathode; and allowing the wastewater comprising humic substances to pass through the electrochemical device.

In a class of this embodiment, a current density is 5-30 mA/cm² during electrochemical oxidation.

The following advantages are associated with the electrode, the preparation method and uses thereof:

1. Magnetic nanoparticles bind to SnO₂—Sb to form a catalyst layer in the form of particles; the catalyst layer is attached to the microporous titanium substrate through an external magnetic field to form an electrode; the microporous titanium substrate is loaded with the particles with space left between the particles and the micropores, so that the electrode can filter pollutants out of wastewater; and the particles preferentially absorb the pollutants thus reducing chances of the pollutants to block the membrane pores.

2. The size of the magnetic SnO₂—Sb particles is 1.2-2.5 times the size of the membrane pores. The particles are attached to the outer surface of the microporous titanium substrate and the space between the microparticles and the pores of the microporous titanium substrate is formed; the space prevents the pollutants from blocking the membrane pores and filters the pollutants out of the wastewater. Experimental results show that the size of the magnetic SnO₂—Sb particles is preferably 1.2-2.0 times the total volume of the membrane pores.

3. The magnetic SnO₂—Sb particles are composite particles formed by embedding the SnO₂—Sb particles with the iron tetroxide nanoparticles. Compared with the core-shell type particles, the microporous titanium substrate and the catalyst layer comprise the same material capable of being melted into a stable whole structure during high-temperature calcination, and no surface cracks are observed. The magnetic SnO₂—Sb particles have catalyst activities and can be fixedly loaded onto the microporous titanium substrate with a magnetic field strength. The thickness of the catalyst layer is adjustable, and the catalyst layer is dynamically replaceable, thus overcoming the disadvantages of a conventional Ti/SnO₂—Sb electrode, such as low catalyst loading and unstable binding.

### BRIEF DESCRIPTION OF THE DRAWINGS

FIG. 1 is a perspective view of a membrane electrode assembly comprising an electrode comprising a catalyst layer comprising magnetic SnO₂—Sb particles according to one example of the disclosure;

FIG. 2 is a scanning electron microscope image of a microporous titanium substrate and magnetic SnO₂—Sb particles in Example 1; and an energy-dispersive X-ray spectroscopy spectra showing the elemental composition of the magnetic SnO₂—Sb particles in Example 1;

FIG. 3 is an X-ray photoelectron spectra (XPS) of magnetic SnO₂—Sb particles according to Example 1 of the disclosure;

FIG. 4 is a fluorescence spectroscopy of a leachate during a degradation analysis according to Example 2 of the disclosure;

FIG. 5 is a line graph showing the pollutant degradation efficiency according to Example 3 of the disclosure;

FIG. 6 is a comparison line graph showing pollutant degradation efficiency of magnetic SnO₂—Sb particles with different sizes in Example 4;

FIG. 7 is a comparison line graph showing pollutant degradation efficiency of magnetic SnO₂—Sb particles prepared by mixing SnO₂—Sb xerogel powders with iron tetroxide nanoparticles in different mass ratios according to Example 5 of the disclosure; and

FIG. 8 is a comparison line graph showing different current densities on the pollutant degradation efficiency according to Example 6 of the disclosure.

### DETAILED DESCRIPTION

To further illustrate the disclosure, examples detailing an electrode comprising a catalyst layer comprising magnetic SnO₂—Sb particles, a preparation method and uses thereof are described below. It should be noted that the following embodiments are intended to describe and not to limit the disclosure.

The conditions not stated in examples follow traditional or manufacturer instructions. The reagents or instruments without manufacturer's indication are common products available on the market.

Various examples of the disclosure may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 4.5 should be considered to have specifically disclosed subranges such as from 1 to 3, from 2 to 4, etc., as well as individual numbers within that range, for example, 1, 2, 3, and 4. This applies regardless of the breadth of the range.

### Example 1

1. Preparation of magnetic SnO₂—Sb particles.

S1. Preparation of SnO₂—Sb xerogel powders.

17.5 g of SnCl₄.5H₂O was added to 83.5 mL of ethanol and heated at 60° C. for 5 hours. 1.85 mg of NH₄F was dissolved in 7.15 mL of water. 1.71 g of SbCl₃ was dissolved in 3.75 mL of HCl. A mixture was formed by mixing all of the above solutions together and then was placed on an ice bath. 38.5 mL of propylene oxide was dissolved in 60 mL of ethanol, added to the mixture, and heated at 40° C. for 48 hours to form a white gel. 150 mL of ethanol containing 5% (v/v) of tetraethyl orthosilicate was added to the white gel and allowed to rest for three days with daily ten-minute-sonication. The sonicated gel was washed with n-hexane, air dried, and heated in a muffle furnace at 450° C., ground to pass through a 200-500 mesh sieve, thus forming SnO₂—Sb xerogel powders in the size of micron.

S2. Preparation of a Sn—Sb precursor solution.

Citric acid: ethylene glycol: SnCl₄.5H₂O: SbCl₃ were mixed in a ratio to form a Sn—Sb precursor solution.

S3. Preparation of magnetic SnO₂—Sb particles.

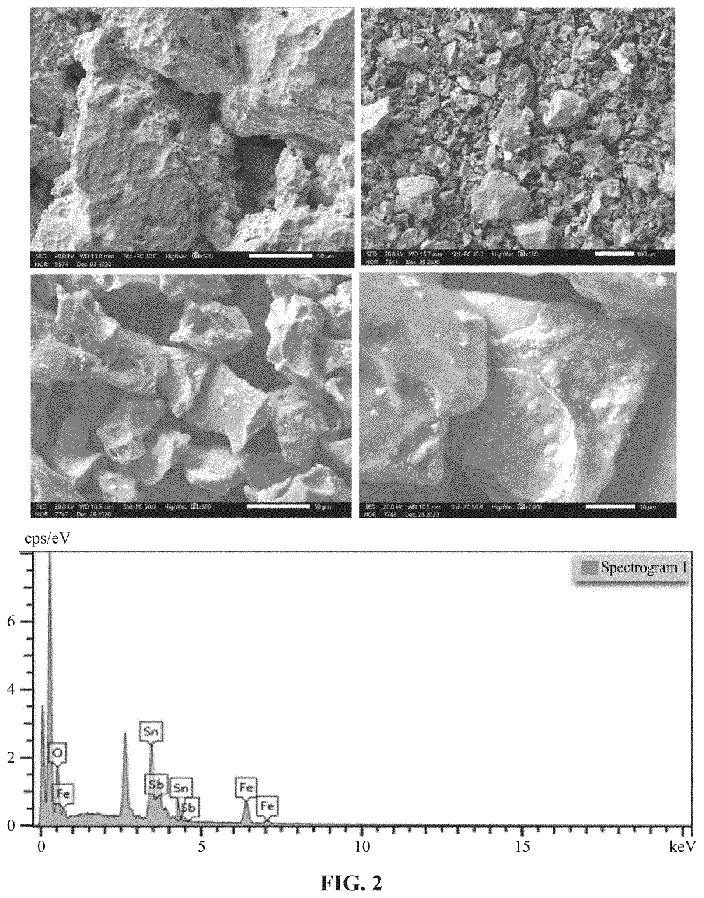

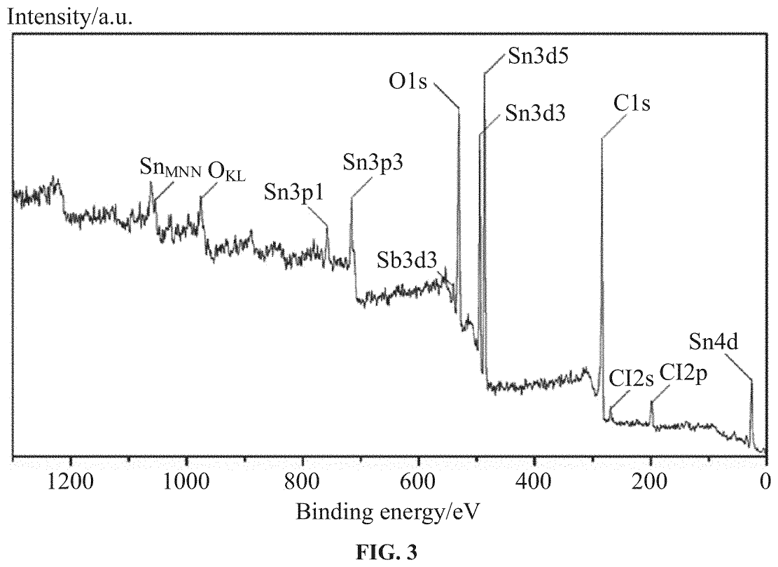

5 g of SnO₂—Sb xerogel powders was mixed with 5 g of iron tetroxide nanoparticles with a particle size of 50-200 nm. 20 mL of the Sn—Sb precursor solution was added, mixed, and heated until the solvent evaporated to obtain a black solid block. The black solid block was placed in the muffle furnace at 450° C. for 30 minutes, and the heat was increased at a rate of 1.5° C./min. The heated black solid block was ground to pass through a 200-500 mesh sieve, immersed in 5% sulfuric acid for 24 hours, and dried to obtain magnetic SnO₂—Sb particles with a size of 30-50 μm. Referring to FIG. 2, the magnetic SnO₂—Sb particles were in the level of micron, and no surface cracks were observed. Referring to FIGS. 2 and 3, the amount of Fe content on the surface of the magnetic SnO₂—Sb particles was reduced because the iron tetroxide was coated with the antimony-doped tin oxide to preserve their magnetic properties and prevent iron leaching.

2. Preparation of an electrode comprising a catalyst layer comprising magnetic SnO₂—Sb particles.

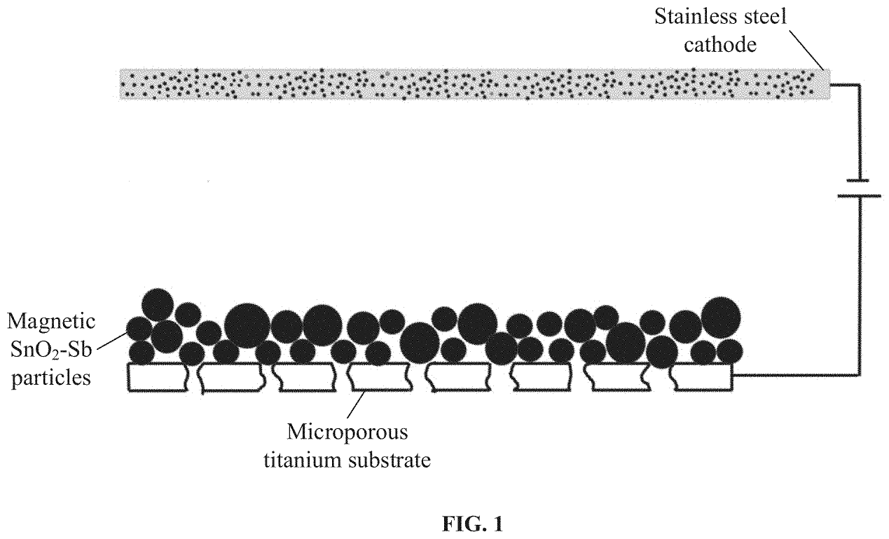

The magnetic SnO₂—Sb particles were passed through a 300 mesh sieve to obtain fine particles. 0.5 g of the fine particles was ultrasonically dispersed in deionized water, captured on the surface of a microporous titanium substrate by filtration, and fixed on the microporous titanium substrate with a strong magnetic strength to obtain an electrode comprising a catalyst layer comprising magnetic SnO₂—Sb particles, as shown in FIG. 1. The microporous titanium substrate has an effective area of 20 cm² and a membrane pore of 20 μm.

### Example 2

An electrochemical device comprised an anode and a cathode. The cathode was a perforated stainless steel, and the anode was the electrode in Example 1. The electrode was the microporous titanium substrate loaded with 10 mg/m² magnetic SnO₂—Sb particles. Electricity was generated to degrade pollutants as water flows downhill.

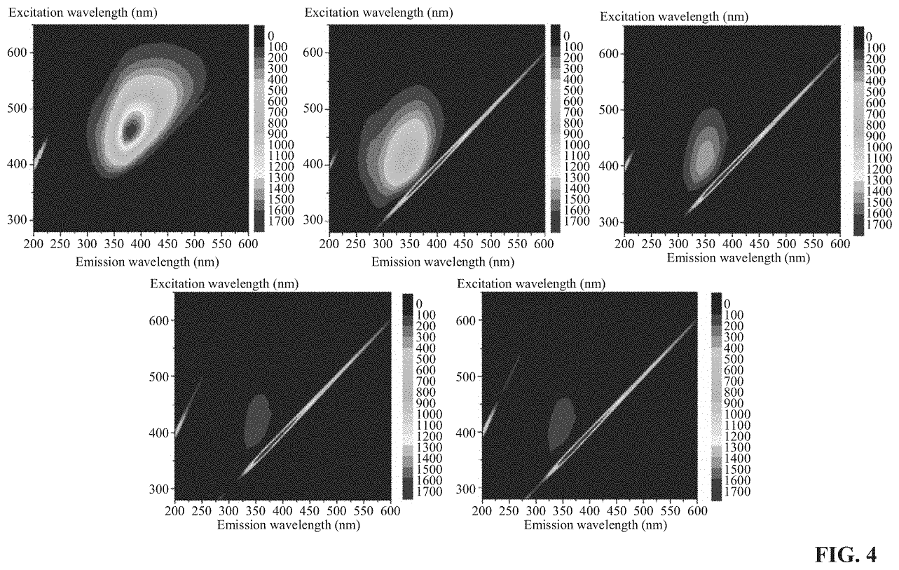

500 mL of leachate was collected from a waste landfill and used for degradation analysis. The leachate contained 640 mg/L COD produced by humus and microbial metabolites. The leachate was degraded under conditions below: the current density was 20 mA/cm², the flow rate was 50 mL/min, and the degradation time was 4 hours. 3D fluorescence spectrum analysis (EEM) was conducted to evaluate the degradation of the leachate at 0 h, 2 h, 3 h, and 4 h. Referring to FIG. 4, humic acid showed a gradual decrease in fluorescent area and intensity at Ex/Em>250 nm/>380 nm, and microbial metabolites showed a gradual decrease in fluorescent area and intensity at Ex/Em>250 nm/<380 nm. The results showed that the substances in the leachate, such as humic acid, were degraded, indicating that the membrane electrode assembly was effective in the removal of pollutants in the water.

### Example 3

0 g, 0.5 g, 1.0 g, and 1.5 g of the fine particles in Example 1 were ultrasonically dispersed in deionized water, captured on the surface of a microporous titanium substrate by filtration, and fixed on the microporous titanium substrate with a strong magnetic strength to obtain an electrode comprising a catalyst layer comprising magnetic SnO₂—Sb particles. The microporous titanium substrate has an effective area of 20 cm².

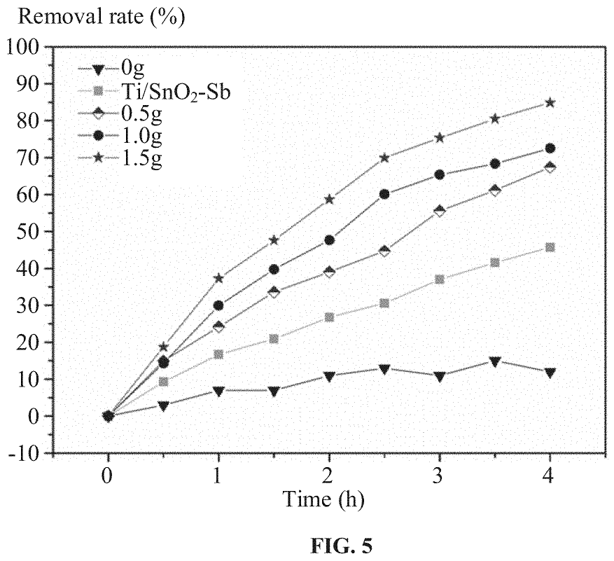

500 mL of leachate was collected from a waste landfill and used for degradation analysis. A microporous Ti/SnO₂—Sb electrode (disclosed in Example 2 of Chinese Patent Application CN106186205A) was used as a control. The leachate contained 716 mg/L COD produced by humus, proteins, and microbial metabolites. The leachate was degraded under conditions below: the current density was 20 mA/cm², the flow rate was 50 mL/min, and the degradation time was 4 hours. Referring to FIG. 5, the conventional microporous Ti/SnO₂—Sb electrode is not effective in degradation of the leachate, as compared to the electrode provided with a catalyst layer with different thicknesses (0.1 g/20 cm², 0.5 g/20 cm², 1.0 g/20 cm², and 1.5 g/20 cm², i.e. 5 mg/cm², 25 mg/cm², 50 mg/cm², and 75 mg/cm²). With increasing thickness or loading amount of the catalyst layer, the performance of degradation in the leachate was improved. The microporous titanium substrate had no catalytic activity and was magnetically bound to the catalytic layer to have the catalytic activity.

### Example 4

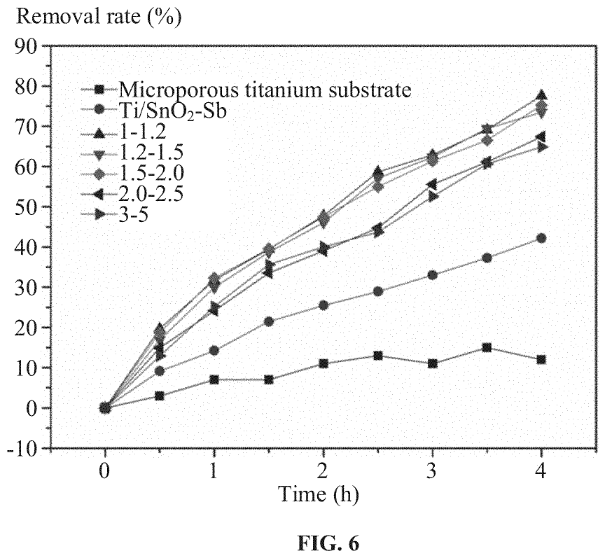

The fourth example of the disclosure is similar to the Example 1, except for the following differences: the magnetic SnO₂—Sb particles were passed through different mesh sieves to obtain the particles of different particle sizes. The ratio of the particle size to the substrate pore size was 1-1.2:1, 1.2-1.5:1, 1.5-2.0:1, 2.0-2.5:1, 3-5:1. 1.0 g of the magnetic SnO₂—Sb particles of different particle sizes was ultrasonically dispersed in deionized water, captured on the surface of a microporous titanium substrate by filtration, and fixed on the microporous titanium substrate with a strong magnetic strength to obtain an electrode comprising a catalyst layer comprising magnetic SnO₂—Sb particles. The microporous titanium substrate had an effective area of 20 cm². 500 mL of leachate was collected from a waste landfill and used for degradation analysis. The leachate contained 716 mg/L COD produced by humus, proteins, and microbial metabolites. The leachate was degraded under conditions below: the current density was 20 mA/cm², the flow rate was 50 mL/min, and the degradation time was 4 hours. Referring to FIG. 6, when the ratio of particle size to substrate pore size was (1.0-2.0):1, there is no significant difference in the removal rate, and the surface particles are partially embedded in the substrate to improve the binding capacity; when the ratio of particle size to substrate pore size was 1:1.2, the magnetic SnO₂—Sb particles may block the membrane pores; when particle size continued to increase, the particles cannot be embedded in the substrate, which affects the removal efficiency of pollutants in the water.

### Example 5

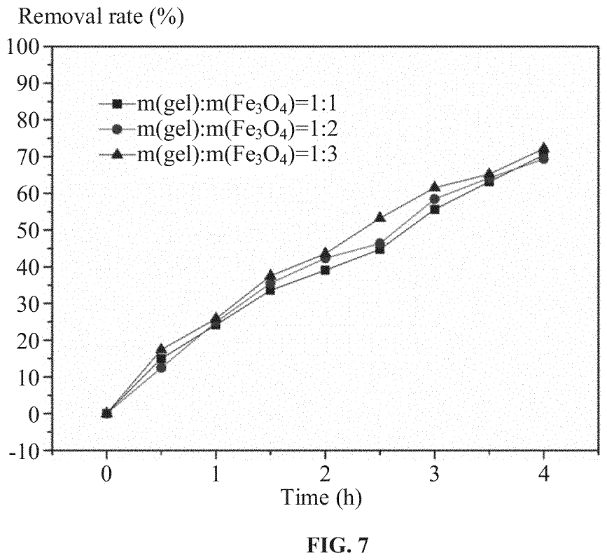

The fifth example of the disclosure is similar to the Example 1, except for the following differences: in 3), the magnetic SnO₂—Sb particles were prepared by mixing 2 g and 3 g of the SnO₂—Sb xerogel powders with 6 g of iron tetroxide nanoparticles with a particle size of 50-200 nm. 1.0 g of the magnetic SnO₂—Sb particles were ultrasonically dispersed in deionized water, captured on the surface of a microporous titanium substrate by filtration, and fixed on the microporous titanium substrate with a strong magnetic strength to obtain an electrode comprising a catalyst layer comprising magnetic SnO₂—Sb particles. The microporous titanium substrate has an effective area of 20 cm². 500 mL of leachate was collected from a waste landfill and used for degradation analysis. The leachate contained 716 mg/L COD produced by humus, proteins, and microbial metabolites. The degradation of the leachate was performed under conditions below: the current density was 20 mA/cm², the flow rate was 50 mL/min, and the degradation time was 4 hours. Referring to FIG. 7, the SnO₂—Sb xerogel powders and the iron tetroxide nanoparticles can be mixed in a mass ratio of 1:1 because different ratios thereof had little effect on pollutant removal rate.

### Example 6

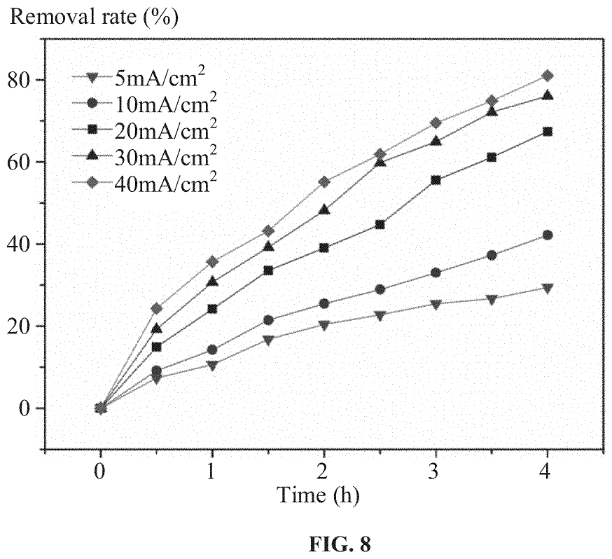

0.5 g of the magnetic SnO₂—Sb particles in Example 1 was ultrasonically dispersed in deionized water, captured on the surface of a microporous titanium substrate by filtration, and fixed on the microporous titanium substrate with a strong magnetic strength to obtain an electrode comprising a catalyst layer comprising magnetic SnO₂—Sb particles. The microporous titanium substrate has an effective area of 20 cm² (i.e. 25 mg/cm²). 500 mL of leachate was collected from a waste landfill and used for degradation analysis. The leachate contained 716 mg/L COD produced by humus, proteins, and microbial metabolites. The degradation of the leachate was performed under conditions below: the current density was 5 mA/cm², 10 mA/cm², 20 mA/cm², 30 mA/cm², and 40 mA/cm², the flow rate was 50 mL/min, and the degradation time was 4 hours. Referring to FIG. 8, the current density was an important factor affecting the electrochemical performance of a membrane electrode assembly. The pollutant removal rate increased with the increase of the current density. The pollutant removal rate dropped to the lowest level of 30% when the current density was 5 mA/cm². The pollutant removal rate rose to above 60% when the current density was 20 mA/cm². The pollutant removal rate reached its peak of above 80% when the current density was 40 mA/cm². When the current density is too high, electricity splits water into hydrogen at the cathode and oxygen at the anode. Thermal energy consumption is high at higher current density, and the oxidation efficiency is lower. The results showed that the pollutant removal rate was increased by more than 20% when the current density was increased from 10 mA/cm² to 20 mA/cm²; the pollutant removal rate was increased by less than 15% when the current density was increased from 20 mA/cm² to 30 mA/cm²; the pollutant removal rate was increased by less than 10% when the current density was increased from 30 mA/cm² to 40 mA/cm².

In certain examples, the microporous titanium substrate with a membrane pore of 5 μm was loaded with the magnetic SnO₂—Sb particles of about 10 μm; the leachate was collected from a waste landfill and used for degradation analysis; and the leachate was degraded under conditions as described in Example 1 so that the pollutants can be removed from the leachate.

In certain examples, the microporous titanium substrate with a membrane pore of 10 μm was loaded with the magnetic SnO₂—Sb particles of about 20-25 μm; the leachate was collected from a waste landfill and used for degradation analysis; and the leachate was degraded under conditions as described in Example 1 so that the pollutants can be removed from the leachate.

In certain examples, the microporous titanium substrate with a membrane pore of 50 μm was loaded with the magnetic SnO₂—Sb particles of about 70-100 μm; the leachate was collected from a waste landfill and used for degradation analysis; and the leachate was degraded under conditions as described in Example 1 so that the pollutants can be removed from the leachate.

The disclosure provides a method for removing pollutants from wastewater by using a membrane electrode assembly based on electrochemical oxidation. The membrane can also intercept the pollutants. Humic acid is a compound with a large molecular weight and a complex structure, which carries a large number of charged groups. In addition to being oxidized in water, part of humic acid is intercepted and trapped on the surface of the membrane due to the repulsion of the magnetic field. The smaller the membrane pore, the better the interception effect. But a smaller membrane pore may cause high transmembrane pressure. The larger membrane pore may result in the poor interception effect. The larger the particle size of the same loading amount of the magnetic particles, the poorer the covering effect on the substrate membrane and the less active sites, which inhibits the electrochemical reaction and effects the removal of the pollutants in water. Therefore, a reduction in the membrane pore size is beneficial to the removal effect while requiring strict operating conditions; but an increase in the membrane pore size may affect the removal of the pollutants in water.

It will be obvious to those skilled in the art that changes and modifications may be made, and therefore, the aim in the appended claims is to cover all such changes and modifications.

The invention claimed is:

1. An electrode, comprising a microporous titanium substrate coated with a catalytic layer, and the catalytic layer comprising magnetic SnO₂—Sb particles; the magnetic SnO₂—Sb particles are attached to the microporous titanium substrate through an external magnetic field; and the microporous titanium substrate comprises a plurality of membrane pores having a pore size of 5-50 μm that is smaller than a particle size of the magnetic SnO₂—Sb particles.

2. The electrode of claim 1, wherein the particle size of the magnetic SnO₂—Sb particles is 1.2-2.5 times the pore size of the membrane pores.

3. The electrode of claim 2, wherein the particle size of the magnetic SnO₂—Sb particles is 1.5-2.0 times the pore size of the membrane pores.

4. The electrode of claim 1, wherein the magnetic SnO₂—Sb particles are composite particles comprising SnO₂—Sb xerogel powders and magnetic nanoparticles; and a capacity of the magnetic nanoparticles on the microporous titanium substrate is 5-75 mg/cm².

5. A method of preparing the electrode of claim 1, the method comprising filtering and loading the magnetic SnO₂—Sb particles onto the microporous titanium substrate to form a catalyst layer; and fixing the catalyst layer on the microporous titanium substrate through a magnetic field to form the electrode comprising the catalyst layer comprising the magnetic SnO₂—Sb particles.

6. The method of claim 5, wherein operations for preparing the magnetic SnO₂—Sb particles comprise:
S1. preparation of SnO₂—Sb xerogel powders;
S2. preparation of a Sn—Sb precursor solution; and
S3. dispersing the SnO₂—Sb xerogel powders and iron tetroxide nanoparticles in the Sn—Sb precursor solution to form a mixture; heating, calcining, and grinding the mixture to form the magnetic SnO₂—Sb particles.

7. The method of claim 6, wherein:
S1 comprises: mixing an ethanol solution of SnCl₄.5H₂O, a NH₄F aqueous solution, and a hydrochloric acid solution of SbCl₃ to form a mixed solution; dissolving an ethanol solution of propylene oxide in the mixed solution and heating to form a white gel; adding an ethanol solution of tetraethyl orthosilicate to the white gel, resting, sonicating, washing the white gel with n-hexane, air drying, and heating in a muffle furnace, to yield a SnO₂—Sb gel; and grinding the SnO₂—Sb gel, sieving through a mesh sieve, thus obtaining the SnO₂—Sb xerogel powders;
S2 comprises: mixing citric acid, ethylene glycol, SnCl₄.5H₂O, and SbCl₃ to form the Sn—Sb precursor solution; and
S3 comprises: mixing the SnO₂—Sb xerogel powders with the iron tetroxide nanoparticles to form a powder mixture; adding the Sn—Sb precursor solution to the powder mixture to form a solution; heating the solution to evaporate solvents, thus obtaining a black solid block; calcining the black solid block in the muffle furnace; grinding and sieving the black solid block, immersing in an acid, and drying to obtain the magnetic SnO₂—Sb particles.

8. The method of claim 7, wherein in S2, a molar ratio of the citric acid to ethylene glycol to SnCl₄.5H₂O to SbCl₃ is 140:30:9:1.

9. The method of claim 7, wherein:
in S3, the iron tetroxide nanoparticles have a particle size of 50-200 nm, and the SnO₂—Sb xerogel powders have a particle size of 10-50 μm;
a mass ratio of the iron tetroxide nanoparticles to the SnO₂—Sb xerogel powders is between 1:1 and 1:3;
every 10 mL of the Sn—Sb precursor solution is added to 10 g of the powder mixture;
the black solid block is calcined in the muffle furnace at a temperature of 350-550° C. with a heating rate of 1.5-5° C./min for 0.5-2 h; and
the black solid block is sieved through a 200-800 mesh sieve and immersed in 5-10 wt. % sulfuric acid, hydrochloric acid, or nitric acid.

10. An electrochemical device, comprising the electrode of claim 1 which operates as an anode of the electrochemical device.

11. A method for treatment of wastewater comprising humic substances, the method comprising horizontally placing the electrochemical device of claim 10 on ground, the electrochemical device comprising the electrode as an anode, and perforated stainless steel as a cathode; and allowing the wastewater comprising humic substances to pass through the electrochemical device.
